(19) United States
(12) Patent Application Publication
(10) Pub. No.: US 2024/0190137 A1
(43) Pub. Date: Jun. 13, 2024

(54) PRINT MATERIAL USAGE ESTIMATION

(71) Applicant: Hewlett-Packard Development Company, L.P., Spring, TX (US)

(72) Inventors: Oscar GOMEZ CAMPS, Sant Cugat del Valles (ES); Alexander Jose PEREZ GARCIA, Sant Cugat del Valles (ES); Cristian DIEZ QUILEZ, Sant Cugat del Valles (ES); Ana OROPESA FISICA, Sant Cugat del Valles (ES); Dorkaitz Alain VAZQUEZ FERNANDEZ, Sant Cugat del Valles (ES); Sara ESTRAVIS NIETO, Leon (ES)

(73) Assignee: Hewlett-Packard Development Company, L.P., Spring, TX (US)

(21) Appl. No.: 18/556,441

(22) PCT Filed: Apr. 21, 2021
(86) PCT No.: PCT/US2021/028496

§ 371 Date: Oct. 20, 2023

(51) Int. Cl. B41J 2/175; B41J 2/165

(52) U.S. Cl. CPC B41J 2/17566; B41J 2/16505

(57) ABSTRACT

The present disclosure relates to methods and devices for estimating an amount of print material available in a print material reservoir of a printer. In an example there is disclosed a method comprising determining a first value for an amount of print material contained within a print material container. The method may further comprise determining, after a printhead maintenance event comprising ejecting print material into a spittoon, a second value for the amount of print material contained within the print material container. The method may further comprise estimating, based on a difference between the first value and the second value, an amount of print material remaining in the print material reservoir.

### BACKGROUND

An inkjet printer is a non-impact printing device that forms characters and other images by ejecting ink drops in a controllable way from a printhead. Inkjet printing mechanisms may be used in different devices such as printers, plotters, facsimile machines, copiers and the like.

The printhead of a machine of the kind mentioned may eject ink through multiple nozzles in the form of minuscule drops or droplets which “fly” for a small distance and strike a print medium. Different printheads may be used for different colours. Inkjet printers may usually print within a range of 180 to 2400 or more dots per inch. The ink drops are dried upon the print media soon after being deposited to form the printed images.

Many printers deposit print material on a print medium. Printing may be carried out by passing the print medium along a printing path. A printer carriage may be passed over the print medium at a print location along a scan axis. The scan axis may be perpendicular to the direction of movement of the print medium along the printing path. Print media may be made of materials such as paper, Mylar, vinyl and textiles, for example. Print media may have different thicknesses.

In inkjet printing systems and devices, a liquid is controllably ejected from the printhead onto the medium. As defined herein and in the appended claims, a “liquid” may be broadly understood to mean a fluid in liquid form, not composed primarily of a gas or gases, that is amenable to controlled ejection from an inkjet printhead. The liquid may be referred to as a printing liquid, which in some cases may be an ink. Thus a “liquid” may encompass printing liquids of various visible colours and/or invisible printing liquids.

### BRIEF DESCRIPTION OF DRAWINGS

Non-limiting examples will now be described with reference to the accompanying drawings, in which:

FIG. 1 is a flowchart of a method according to some examples;

FIG. 2 is another flowchart of a method according to some examples;

FIG. 3 is another flowchart of a method according to some examples;

FIG. 4 is another flowchart of a method according to some examples;

FIG. 5 is a simplified schematic of a device according to some examples; and

FIG. 6 is a simplified schematic of another device according to some examples.

### DETAILED DESCRIPTION

Many printers may determine the amount of print material, such as ink, remaining in a print material supply of the printer using drop counting. This drop counting may estimate the amount of ink consumed or fired during printing based on the number of drops or droplets ejected by the printhead and an estimated weight of each one of the drops or droplets. This method may lead to inaccuracies due to the dispersion of drop weight. Printers may use this determination to monitor the amount of print material of the supply and detect an out-of-ink condition, which may prompt the printer to alert a user that a refill of the supply may be needed.

In some examples, there is provided a method that may improve the calibration of the drop counting by using service operations, for example by calibrating the predefined average drop weight to a current drop weight. Such service operations may be performed as part of the general operation of the printer, such as during printing. Such service operations may include printhead maintenance events. By improving the calibration of the drop counting, the error in the method may be reduced without requiring additional time and resources. By improving the accuracy of the method, the overall performance of the printer, and the customer experience, may be improved.

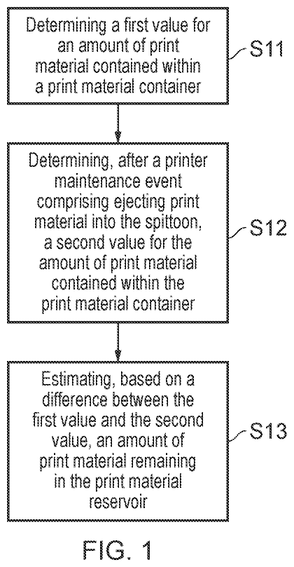

FIG. 1 presents a flowchart of a method according to some examples. In the example according to FIG. 1, the method may comprise determining S11 a first value for an amount of print material contained within a print material container. The method may further comprise determining S12 a second value for the amount of print material contained within the print material container. The second value may be determined after a printhead maintenance event comprising ejecting print material into a spittoon. Finally, the method may comprise estimating S13 an amount of print material remaining in the print material reservoir. The estimating may be based on a difference between the first value and the second value. In one example the print material container may be the spittoon. In another example, the print material container may be the print material reservoir.

In some examples, first and second values for the amount of print material contained within a print material container can be determined for the spittoon and for the print material reservoir. In such examples, the first and second spittoon values and the first and second print material reservoir values can be used to estimate the amount of print material remaining in the print material reservoir. By using measurements from the spittoon and the print material reservoir, the accuracy of the estimation may be increased.

In some examples, where the print material container is the spittoon, the first value may be zero, i.e. no print material is contained in the spittoon. This may be the case before a first printhead maintenance event. A printhead maintenance event may include a spitting event where print material is ejected from the printhead into the spittoon to clear dried print material from around the printhead nozzle. In a further example, the first value may include print material from a previous printhead maintenance event. The amount of print material may be determined in a number of ways, set out below.

In an example, determining S11 the first value may include determining the weight of the container. Similarly, determining S12 the second value may include determining the weight of the container. Determining the weight of the container may comprise measuring the weight using a weight sensor. The weight sensor may be located underneath the container, and may measure the weight of the container. In some examples, the weight may be determined by a user. This weight may then be input to the printer by the user. Possible input methods include an input screen, which may be positioned on a front panel of the printer. In examples where the weight of the container is determined, the dependency of the method on the viscosity of the print material may be reduced as the determination of weight may not be dependent on the print material being evenly distributed. Thus, the accuracy of the method may be improved as the method may not be as impacted by the variance in viscosity as a result of environmental factors, for example the temperature of the print material.

In a further example, determining the first value for an amount of print material contained within the container S11 may include using level sensing. Level sensing may involve detecting a level or amount of print material contained in the container. Level sensing may be performed using a camera or other print material sensor. Similarly, determining, after a printhead maintenance event, which comprises ejecting print material into the spittoon, the second value for the amount of print material contained within the container S12 may include using level sensing.

Print material may include a printing fluid or liquid. Print material may also include ink. The printhead maintenance event comprising ejecting print material into the spittoon may be a spit event. Printhead maintenance events may be performed intermittently to maintain the working state of the printhead. The print material reservoir may be a printer ink cartridge.

Estimating the amount of print material remaining in the print reservoir S13 may comprise using a linear regression algorithm to calculate the amount of print material consumed by the print maintenance event. The linear regression algorithm may include an aerosol correction factor. The aerosol correction factor may account for the amount of aerosol produced during the printhead maintenance event, which may for example impact the determination of the first and second values for the amount of print material contained within the spittoon, and thus may improve the accuracy of the linear regression algorithm and the resulting calculated amount of consumed print material. An aerosol correction factor may, in an example, be applied when estimating S13 the amount of print material remaining in the print material reservoir. The aerosol correction factor may be determined based on the type of print material and/or ambient conditions, which may affect the amount of aerosol produced in a predictable manner.

A time between the printhead maintenance event and the determination of the second value for the amount of print material contained within the print material container may be below a maximum threshold. This threshold may be an amount of time under which the evaporation of liquid from the spittoon is minimal. Thus, if the time between the printhead maintenance event and the determination of the second value for the amount of print material contained within the spittoon is below this value the impact of liquid evaporation in the spittoon may be reduced and the accuracy of the method may be improved. The threshold may be dependent on the type of print material and/or the ambient conditions (temperature, humidity, etc.).

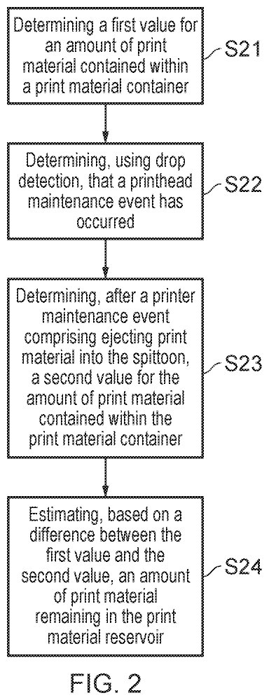

FIG. 2 presents a flowchart of a method according to further examples. In the example according to FIG. 2, the method may comprise determining S21 a first value for an amount of print material contained within a print material container. The method may further comprise determining S22, using drop detection, that a printhead maintenance event has occurred. In addition, the method may comprise determining S23, after the printhead maintenance event comprising ejecting print material into a spittoon, a second value for the amount of print material contained within the print material container. Finally, the method may comprise estimating S24, based on a difference between the first value and the second value, an amount of print material remaining in the print material reservoir.

In an example as presented in FIG. 2, drop detection may comprise the detection of drops and/or droplets being ejected from the printhead nozzles. Drop detection may be useful to detect potential blockages in the printhead nozzles. The drop detector may comprise a light emitting system and an optical sensor or optical receiver. The light emitting system may comprise a diode. The optical sensor may detect fired drops by detecting changes in the received signal from the light emitting system. Alternatively, the drop detector may comprise a camera or any other device that would allow for the detection of drops or droplets.

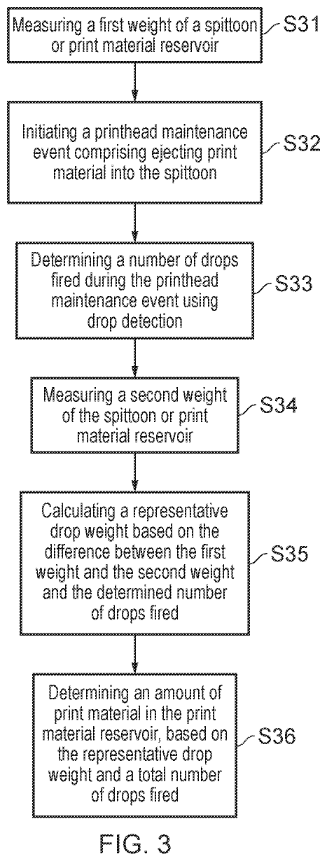

FIG. 3 presents a flowchart of a method according to some examples. In the example according to FIG. 3, the method may comprise measuring S31 a first weight of a spittoon. The method may further comprise initiating S32 a printhead maintenance event. The print maintenance event may comprise ejecting print material into the spittoon. In addition, the method may comprise determining S33 a number of drops fired during the printhead maintenance event. The number of drops fired may be determined by drop detection. The method may comprise measuring S34 a second weight of the spittoon. Additionally, the method may comprise calculating S35 a representative drop weight. This calculation may be based on the difference between the first weight and the second weight of the spittoon and the determined number of drops fired. Finally, the method may comprise determining S36 an amount of print material in the print material reservoir. This determination may be based on the representative drop weight and a total number of drops fired.

In another example in accordance with FIG. 3, the method may comprise measuring S31 a first weight of the print material reservoir. The method may further comprise initiating S32 a printhead maintenance event. The print maintenance event may comprise ejecting print material, for example into a spittoon. In addition, the method may comprise determining S33 a number of drops fired during the printhead maintenance event. The number of drops fired may be determined by drop detection. The method may comprise measuring S34 a second weight of the print material reservoir. Additionally, the method may comprise calculating S35 a representative drop weight. This calculation may be based on the difference between the first weight and the second weight of the print material reservoir and the determined number of drops fired. Finally, the method may comprise determining S36 an amount of print material in the print material reservoir. This determination may be based on the representative drop weight and a total number of drops fired.

In an additional example in accordance with FIG. 3, the method may comprise measuring S31 a first weight of the print material reservoir and a first weight of the spittoon. The method may further comprise initiating S32 a printhead maintenance event. The print maintenance event may comprise ejecting print material, for example into a spittoon. In addition, the method may comprise determining S33 a number of drops fired during the printhead maintenance event. The number of drops fired may be determined by drop detection. The method may comprise measuring S34 a second weight of the print material reservoir and a second weight of the spittoon. Additionally, the method may comprise calculating S35 a representative drop weight. This calculation may be based on the difference between the first weights and the second weights and the determined number of drops fired. Finally, the method may comprise determining S36 an amount of print material in the print material reservoir. This determination may be based on the representative drop weight and a total number of drops fired. By using measurements from the spittoon and the print material reservoir, the accuracy of the estimation may be increased. The print material in the print material reservoir may not evaporate over time as the print material in the spittoon may, and thus no aerosol correction factor may be applicable for the determination of the first and second print material reservoir values. However, the measurement of the print material in the spittoon may be more accurate as the amount of print material in the spittoon may be significantly smaller than the amount of ink in the print material reservoir.

Measuring the first or second weight of the spittoon and/or the print material reservoir may comprise measuring the weight using a weight sensor. The weight sensor may be located underneath the spittoon, and may weigh the spittoon. In some examples, the weight may be determined by a user. This weight may then be input to the printer by the user. Print material may be a printing fluid or liquid. Print material may also include ink. The printhead maintenance event comprising ejecting print material into the spittoon may be a spit event. The print material reservoir may be a printer ink cartridge.

Determining S36 the amount of print material in the print material reservoir may comprise using a linear regression algorithm to calculate the amount of print material consumed by the print maintenance event. The linear regression algorithm may include an aerosol correction factor. In an example, measuring the first and/or second weight of the spittoon may benefit from using the linear regression algorithm as the aerosol correction factor may account for the amount of aerosol produced during the printhead maintenance event, and thus may improve the accuracy of the linear regression algorithm and the resulting calculated amount of consumed print material.

A time interval between the printhead maintenance event and the determination of the second value may be within a maximum threshold interval. This threshold may be an amount of time within which the evaporation of liquid from the spittoon is minimal. Thus, if the time between the printhead maintenance event and the determination of the second value is below this value the impact of liquid evaporation in the spittoon may be reduced and the accuracy of the method may be improved. If the second value is determined after this threshold, print material may dry in a predictable manner based on the type of print material used and the ambient conditions. Therefore, the second value may be updated based on the time beyond the threshold, the print material type and ambient conditions such as temperature and humidity.

Drop detection may comprise the detection of drops and/or droplets. Drop detection may be used during the print maintenance event to determine how many drops are fired as part of the print maintenance event.

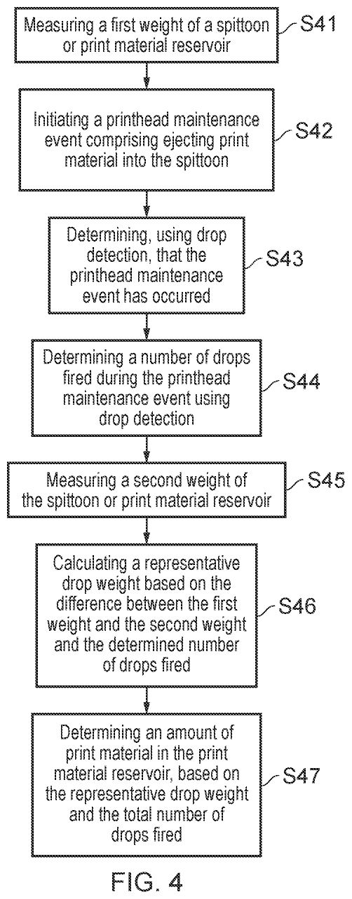

FIG. 4 presents a flowchart of a method according to some examples. In the example according to FIG. 4, the method may comprise measuring S41 a first weight of a spittoon or print material reservoir. The method may further comprise initiating S42 a printhead maintenance event comprising ejecting print material into the spittoon. In addition, the method may comprise determining S43 that the printhead maintenance event has occurred. The determining may be performed by drop detection. In accordance with FIG. 4, the method may comprise determining S44 a number of drops fired during the printhead maintenance event using drop detection. The method may comprise measuring S45 a second weight of the spittoon or print material reservoir. Additionally, the method may comprise calculating S46 a representative drop weight based on the difference between the first weight and the second weight and the determined number of drops fired. Finally, the method may comprise determining S47 an amount of print material in the print material reservoir, based on the representative drop weight and a total number of drops fired.

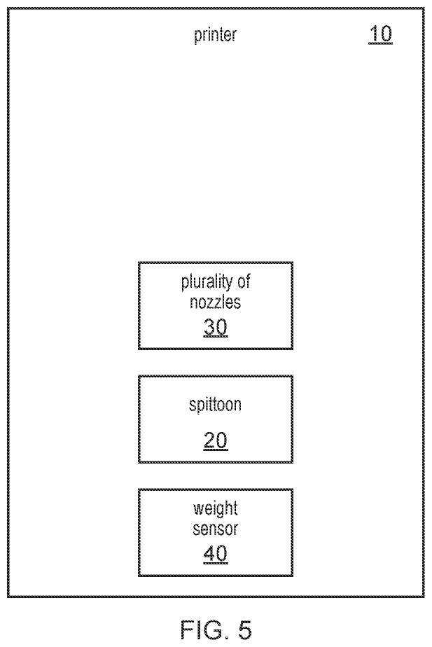

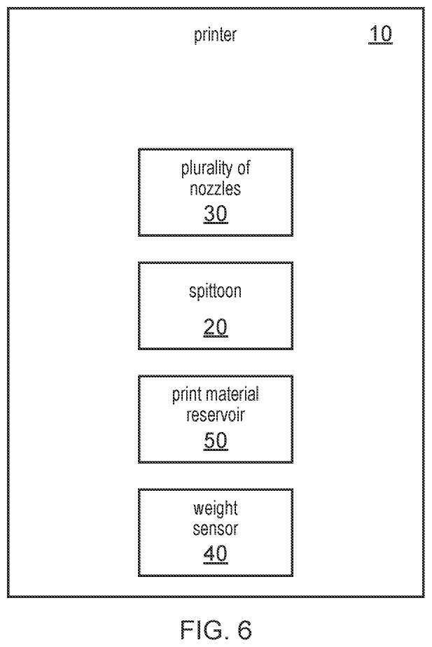

The methods of the present examples may be performed by a device. This device may be a controller. Alternatively, this device may be a printer. In some examples, the device may be as described below in relation to FIGS. 5 and 6.

FIG. 5 is a simplified schematic of a device according to some examples. In the example according to FIG. 5, there may be provided a printer 10. The printer 10 may comprise a spittoon 20. The printer 10 may additionally comprise a plurality of nozzles 30. The spittoon 20 may collect print material deposited by a plurality of nozzles 30 during a printhead maintenance event. The printer 10 may additionally comprise a weight sensor 40. The weight sensor 40 may measure a weight of the spittoon 20 before the printhead maintenance event and after the printhead maintenance event. The weight of the spittoon 20 may be used to calculate an amount of print material available in a print material reservoir.

Print material may be a printing fluid or liquid. Print material may also include ink. The printhead maintenance event comprising ejecting print material into the spittoon may be a spit event. The printer 10 may be calibrated at the time the print material reservoir, for example an ink cartridge, is loaded into the printer 10. Therefore, an initial state in which the print material reservoir is full may be determined. From the initial state, drop detection may be performed to count the number of drops used from the print material supply, in order to calculate a remaining amount of print material left in the print material reservoir. The difference in the weight of the spittoon 20 from before the print maintenance event to after the print maintenance event may be used to recalibrate drop weight to determine an amount of print material remaining in the print material reservoir.

In some examples, an amount of print material contained in a print material reservoir may be determined or input by a user, or otherwise calculated and the weight sensor may be used to monitor depletion of print material supply during printing and print maintenance events. Once a print material supply reaches a low level, for example between 1% and 10% of the total initial supply remaining, a message may be generated prompting the user or printer administrator to refill or order more print material.

The printer may additionally comprise a timer. The timer may measure a time between the printhead maintenance event and the measurement of the weight of the spittoon after the printhead maintenance event. The measured time may be below a maximum threshold. This threshold may be a time under which the evaporation of liquid from the spittoon 20 is minimal. Thus, if the time between the printhead maintenance event and the determination of the second value for the amount of print material contained within the spittoon 20 is below this value the impact of liquid evaporation in the spittoon 20 may be reduced and the accuracy of the method may be improved.

The calculation of the amount of print material available in a print material reservoir may comprise using a linear regression algorithm to calculate the amount of print material consumed by the print maintenance event. The linear regression algorithm may include an aerosol correction factor. The aerosol correction factor may account for the amount of aerosol produced during the printhead maintenance event, and thus may improve the accuracy of the linear regression algorithm and the resulting calculated amount of consumed print material.

The printer 10 may additionally comprise a drop detector. The drop detector may determine that a printhead maintenance event has occurred. Drop detection may comprise the detection of drops and/or droplets. Drop detection may additionally be used during the print maintenance event to determine how many drops are fired as part of the print maintenance event.

FIG. 6 is a simplified schematic of a device according to some examples. In the example according to FIG. 6, there may be provided a printer 10. The printer 10 may comprise a spittoon 20. The printer 10 may additionally comprise a plurality of nozzles 30. The spittoon 20 may collect print material deposited by a plurality of nozzles 30 during a printhead maintenance event. The printer 10 may additionally comprise a print material reservoir 50. The printer may also comprise a weight sensor 40. The weight sensor 40 may measure a weight of the print material reservoir 20 before the printhead maintenance event and after the printhead maintenance event. The weight of the spittoon 20 may be used to calculate an amount of print material available in a print material reservoir.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage or memory that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions may be made without departing from the scope of the present disclosure. It is intended, therefore, that the methods, devices and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single unit may fulfil the functions of several units recited in the claims.

The features of any dependent claim may be combined with the features of any of the independent claims or other dependent claims.

1. A method for estimating an amount of print material available in a print material reservoir of a printer, the method comprising:
determining a first value for an amount of print material contained within a print material container;
determining, after a printhead maintenance event comprising ejecting print material into a spittoon, a second value for the amount of print material contained within the print material container; and
estimating, based on a difference between the first value and the second value, an amount of print material remaining in the print material reservoir.

2. The method as claimed in claim 1, wherein the print material container is a spittoon.

3. The method as claimed in claim 2, wherein determining of the first value and the second value for the amount of print material contained within the spittoon comprises determining a weight of the spittoon.

4. The method as claimed in claim 2, wherein determining of the first value and the second value for the amount of print material contained within the spittoon comprises using level sensing.

5. The method as claimed in claim 1, wherein estimating the amount of print material remaining in the print material reservoir comprises using a linear regression algorithm to calculate an amount of print material consumed by the print maintenance event.

6. The method as claimed in claim 5, wherein the linear regression algorithm includes an aerosol correction factor.

7. The method as claimed in claim 1, further comprising:
determining, using drop detection, that the printhead maintenance event has occurred.

8. The method as claimed in claim 1, wherein a time between the printhead maintenance event and the determination of the second value for the amount of print material contained within the spittoon is below a maximum threshold.

9. A method for determining an amount of print material in a print material reservoir, the method comprising:
measuring a first weight of a spittoon or the print material reservoir;
initiating a printhead maintenance event comprising ejecting print material into the spittoon;
determining a number of drops fired during the printhead maintenance event using drop detection;
measuring a second weight of the spittoon or the print material reservoir;
calculating a representative drop weight based on the difference between the first weight and the second weight of the spittoon or the print material reservoir and the determined number of drops fired; and
determining an amount of print material in the print material reservoir, based on the representative drop weight and a total number of drops fired.

10. The method as claimed in claim 9, wherein measuring the first weight and the second weight of the spittoon or the print material reservoir comprises measuring the weight using a weight sensor.

11. The method as claimed in claim 9, wherein determining the amount of print material in the print material reservoir comprises using a linear regression algorithm to calculate the amount of print material consumed by the print maintenance event.

12. The method as claimed in claim 11, wherein the linear regression algorithm includes an aerosol correction factor.

13. The method as claimed in claim 9, wherein the method additionally comprises:
determining, using drop detection, that the printhead maintenance event has occurred.

14. The method as claimed in claim 9, wherein a time between the printhead maintenance event and the determination of the second weight of the spittoon is below a maximum threshold.

15. A printer comprising:
a spittoon to collect print material deposited by a plurality of nozzles during a printhead maintenance event;
a weight sensor to measure a weight of the spittoon before the printhead maintenance event and after the printhead maintenance event; wherein
the weight of the spittoon is used to calculate an amount of print material available in a print material reservoir.
